(19) United States
(12) Patent Application Publication
(10) Pub. No.: US 2005/0126638 A1
(43) Pub. Date: Jun. 16, 2005

(54) Check valve sealing arrangement

(75) Inventor: Gregory N. Gilbert, Sugar Land, TX (US)

Correspondence Address: CONLEY ROSE, P.C., PO BOX 3267, HOUSTON, TX, 77253-3267, US

(73) Assignee: Halliburton Energy Services, Inc., Houston, TX (US)

(21) Appl. No.: 11/010,024

(22) Filed: Dec. 10, 2004

Related U.S. Application Data
(60) Provisional application No. 60/529,390, filed on Dec. 12, 2003.

(51) Int. Cl. F16K 15/04

(52) U.S. Cl. 137/539

(57) ABSTRACT

Methods and apparatus for sealing a check valve. The check valve includes a closure member, primary and secondary sealing elements, and a spring that urges the closure member into engagement with the primary sealing element. The primary sealing element is retained by a groove formed by the housing and the second sealing elements. Increasing pressure acting on the closure member compresses the primary sealing element and allows the closure member to engage the secondary sealing element. As it compresses, the primary sealing element wipes contamination from the closure member to provide a clean sealing surface for engagement with the secondary sealing element. The secondary sealing element also provides sealing redundancy, which is especially beneficial in gas sealing applications.

### CROSS-REFERENCE TO RELATED APPLICATIONS

The present application claims the benefit of 35 U.S.C. 111(b) provisional application Ser. No. 60/529,30 filed Dec. 12, 2003, and entitled “Check Valve Sealing Arrangement.”

### STATEMENT REGARDING FEDERALLY SPONSORED RESEARCH OR DEVELOPMENT

Not Applicable.

### FIELD OF THE INVENTION

The present invention relates generally to seals for check valves. More particularly, the present invention relates to sealing systems for check valves.

### BACKGROUND

Check valves are unidirectional valves that allow fluid flow in only one direction. Many check valves are considered direct-acting such that the valve is actuated by the application of flowing fluids to the valve. Many of these direct-acting check valves have a closure member that is held in a sealed position by a spring. The valve remains sealed until the fluid pressure on one side of the valve overcomes the force of the spring and moves the closure member. When the flow of fluid is reversed, the fluid pressure, in conjunction with the force of the spring, maintains the closure member in the sealed position. Check valves are commonly used in pumps, control systems, and other applications where a particular fluid path may be subjected to alternating flows.

Modern formation test tools utilize downhole pumps to remove drilling mud and mud filtrate from isolated zones of interest. These downhole pumps use direct-acting check valves to control the direction of fluid entering and exiting the chambers of reciprocating piston-style pump (see FIG. 5). The fluids encountered during the downhole pumping operations are often a mixture of drilling fluids, formation fluids (oil, water or gas), and solid formation materials, such as sand. Sand, and other solid materials, in the fluid can cause the check valves to become fouled, preventing a reliable sealing engagement. Without a reliable seal, the check valve is rendered ineffective to perform the required pumping operations.

Other flow control applications that involve fluids with debris or other contaminants may also utilize check valves. For example, mining applications, machine tool cutting fluid circulation systems, and automotive applications, including engine oil systems. These systems and applications are also susceptible to reliability issues with check valves operating in dirty, or contaminated, environments.

Therefore, a check valve design having improved sand and debris tolerance is desirable. Accordingly, there remains a need to develop improved check valve systems, which overcome certain of the foregoing difficulties while providing more advantageous overall results.

### SUMMARY OF THE PREFERRED EMBODIMENTS

The embodiments of the present invention are directed to methods and apparatus for sealing a check valve. The check valve includes a closure member, primary and secondary sealing elements, and a spring that urges the closure member into engagement with the primary sealing element. The primary sealing element is retained by a groove formed by the housing and the second sealing elements. Increasing pressure acting on the closure member compresses the primary sealing element and allows the closure member to engage the secondary sealing element. As it compresses, the primary sealing element wipes debris from the closure member.

In one embodiment, a check valve comprises a body having first and second ports. An insert is disposed within the body and in fluid communication with both the first and second ports. A closure member is disposed within the insert. A first sealing element is disposed circumferentially about the second port and a second sealing element is disposed adjacent to the first sealing element, wherein the second sealing element forms at least a portion of a groove retaining the first sealing element. A spring is adapted to urge the closure member into engagement with the first sealing element. The closure member has a first sealing position, in which the closure member is sealingly engaged with the first sealing element, and a second sealing position, in which the first sealing element is substantially compressed within the groove and the closure member is sealingly engaged with the second sealing element. In the second sealing position, the first sealing element wipes debris from the closure member.

In an alternate embodiment, a valve assembly comprises a body having first and second ports. A closure member and a primary sealing element are disposed within the body. The assembly also comprises a spring adapted to urge the closure member into sealing engagement with the primary sealing element so as to isolate the first port from the second port. The assembly also comprises a secondary sealing element disposed within the body so as to sealingly engage the closure member as pressure in the first port compresses the closure member against the primary sealing element.

Thus, the present invention comprises a combination of features and advantages that enable it to overcome various shortcomings of prior devices. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of the preferred embodiment of the present invention, reference will now be made to the accompanying drawings, wherein:

FIG. 1 is a cross-sectional view of a prior art check valve;

FIG. 2 is a cross-sectional view of one embodiment of a check valve in accordance with embodiments of the present invention;

FIG. 3 is a cross-sectional view of the check valve of FIG. 2, shown in an open position;

FIG. 4 is a cross-sectional view of the check valve of FIG. 2, shown in a closed position;

FIG. 5 is a cross-sectional view of a pump assembly including check valves constructed in accordance with embodiments of the present invention;

FIG. 6 is a schematic view of a downhole tool pumping section including check valves constructed in accordance with embodiments of the present invention; and

FIG. 7 is a schematic view of a downhole formation testing tool including the pumping section of FIG. 6.

### DETAILED DESCRIPTION OF THE PREFERRED EMBODIMENTS

In the description that follows, like parts are marked throughout the specification and drawings with the same reference numerals, respectively. The drawing figures are not necessarily to scale. Certain features of the invention may be shown exaggerated in scale or in somewhat schematic form and some details of conventional elements may not be shown in the interest of clarity and conciseness. The present invention is susceptible to embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce desired results.

In particular, various embodiments described herein thus comprise a combination of features and advantages that overcome some of the deficiencies or shortcomings of prior art check valve apparatus or systems. The various characteristics mentioned above, as well as other features and characteristics described in more detail below, will be readily apparent to those skilled in the art upon reading the following detailed description of preferred embodiments, and by referring to the accompanying drawings.

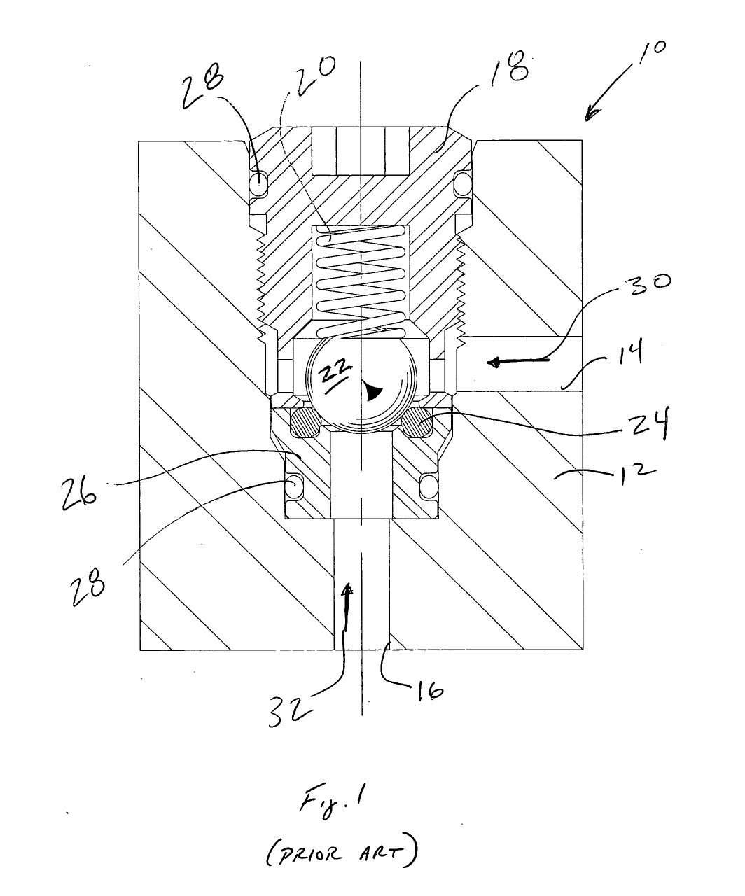

Referring to FIG. 1, a conventional check valve assembly 10 is shown. Assembly 10 includes valve body 12 having two ports 14 and 16, threaded insert 18, spring 20, closure member 22, sealing element 24, seat retainer 26, and static seals 28. Spring 20 urges closure member 22 into initial sealing engagement with the sealing element 24. Closure member 20 is shown as a ball-type closure member. Sealing element 24 is commonly an elastomeric seal, such as an O-ring. Sealing element 24 is captured between seat retainer 26 and threaded insert 18, which prevents dislodgment of the seal during flow reversal.

As fluid pressure is increased in the “checked” direction 30, closure member 22 is further forced into the sealing element 24 until the closure member physically contacts seat retainer 26. Sealing engagement is provided by sealing element 24 being compressed between closure member 22 and seat retainer 26. In the reversed flow, or “un-checked” direction 32, the fluid pressure compresses spring 20 to push closure member 22 away from sealing element 24, and to provide a relatively unrestricted flow path. The pressure required to unseat closure member 22 from sealing element 24, thus permitting flow in the un-checked direction, is called the “cracking” pressure.

As previously discussed, one problem with seal assembly 10 is that, in the presence of solid particles or sand in the fluid while flowing in the un-checked direction, particles tend to build up in between closure member 22 and sealing element 24. Upon flow reversal to the checked direction 30, the built up particles prohibit closure member 22 from making adequate sealing engagement with sealing element 24. Increased spring force has been utilized to further “force” closure member 22 through the debris and into proper contact with sealing element 24. Although this increased spring force is effective in improving the sealability of valve assembly 10, the increased spring force increases the “cracking” pressure of the valve. The higher cracking pressure creates high localized flow velocities through the region in between closure member 22 and sealing element 24, which accelerates erosion of the elastomeric sealing element and the closure member.

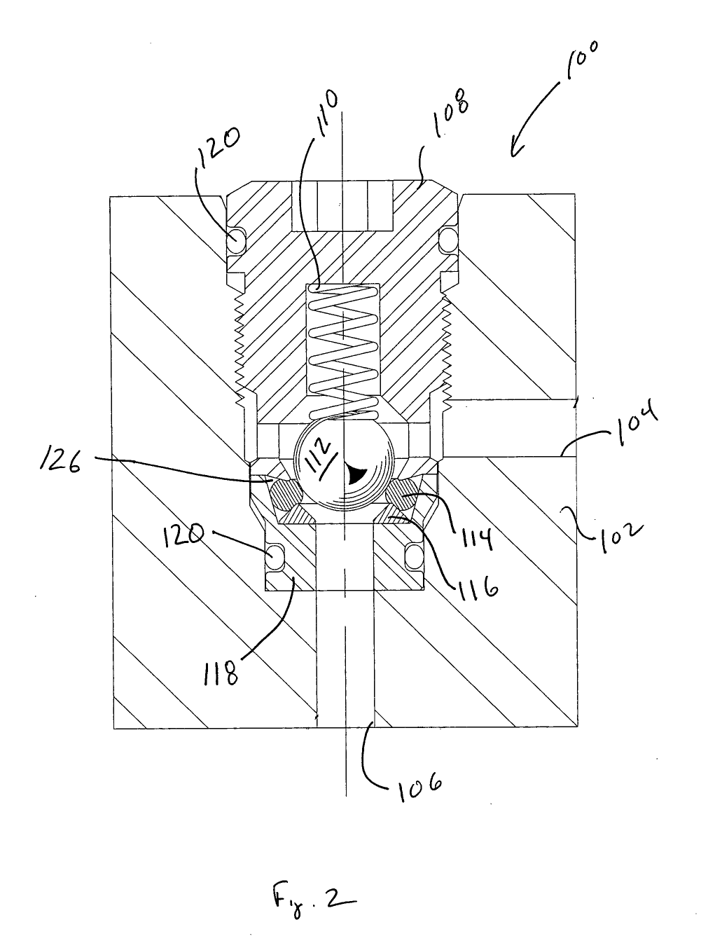

FIG. 2 illustrates one embodiment of a check valve assembly 100 comprising valve body 102 having checked flow port 104 and free flow port 106. Assembly 100 also comprises, threaded insert 108, spring 110, closure member 112, primary sealing element 114, secondary sealing element 116, seat retainer 118, and static seals 120. Closure member 112 may be a ball, hemisphere, or other type of shaped closure member. Threaded insert 108 engages body 102 to hold spring 110 in place against closure member 112.

As shown in FIG. 2, in the presence of zero flow, or balanced pressure across closure member 112, spring 110 urges closure member 112 into initial sealing engagement with the primary sealing element 114. Primary sealing element 114 is disposed within groove 126 formed between threaded insert 108 and secondary sealing element 116, which is supported by seat retainer 118. In certain embodiments, primary sealing element 114 has a circular cross-section sized so as to be retained in groove 126 formed between a triangular cross-sectioned secondary sealing element 116 and the base of threaded insert 108. Groove 126 may be a dove-tailed groove or some other shape to effectively trap primary sealing element 114 to prevent it from becoming dislodged during flow reversals.

Primary sealing element 114 may have any cross-sectional shape or arrangement of shapes that is suitable for a particular application. For example, sealing element 114 may have square, oval, faceted, chevron, or other shaped surfaces and cross-sections. Sealing element 114 may also be a bonded seal comprising a resilient member bonded to another less-resilient member.

Primary sealing element 114 is preferably a compliant, flexible seal, such as an elastomeric O-ring type seal. Materials such as urethane, natural rubber, nitrile rubber, fluorocarbons (Viton®), and perfluoro-elastomers (Kalrez®) may be suitable for use as primary sealing element 114. Secondary sealing element 116 is preferably a polymeric sealing element that is less compliant that primary sealing element 114 and has a cross-section that acts with threaded insert 108 to form groove 126. Secondary sealing element 116 may be constructed from a material such as polyetheretherketone (PEEK), Polytetraflouroethylene (Teflon®), thermoplastics, certain plastics, composites, and other synthetic materials suitable for gas environments. In non-gas working environments, secondary sealing element 116 may be constructed from other materials.

Closure member 112 is preferably constructed from a steel, stainless steel, ceramic, plastic, or other suitable material. Threaded insert 108, seat retainer 118, and spring 110 are preferably constructed from metallic materials but may also be formed from plastics, thermoplastics, and other suitable materials.

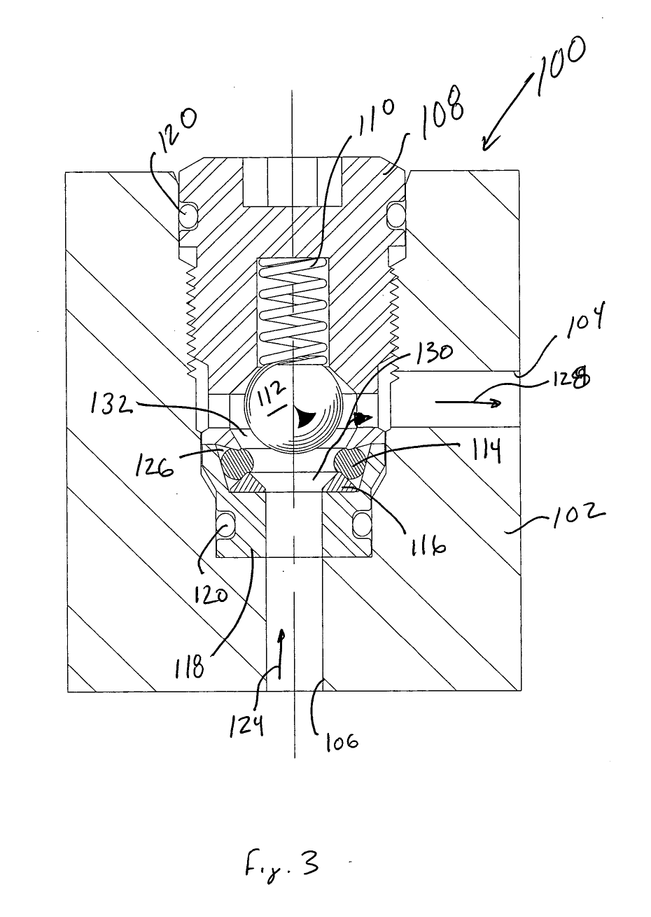

FIG. 3 illustrates valve assembly 100 in an open position supporting fluid flow in a free flow direction 124. As pressure within port 106 increases, spring 110 is compressed and closure member 112 disengages primary sealing element 114. Flow 130 is then allowed to move between closure member 112 and primary sealing element 114. Flow 128 continues through port 104 and out of valve body 102. With closure member 112 disengaged from primary sealing element 114, flow 130 will pass through gap 132 between the closure member and the primary sealing element. Solid particles being carried by flow 130 may tend to deposit within gap 132 or act to erode the sealing surfaces of closure member 112 and primary sealing element 114.

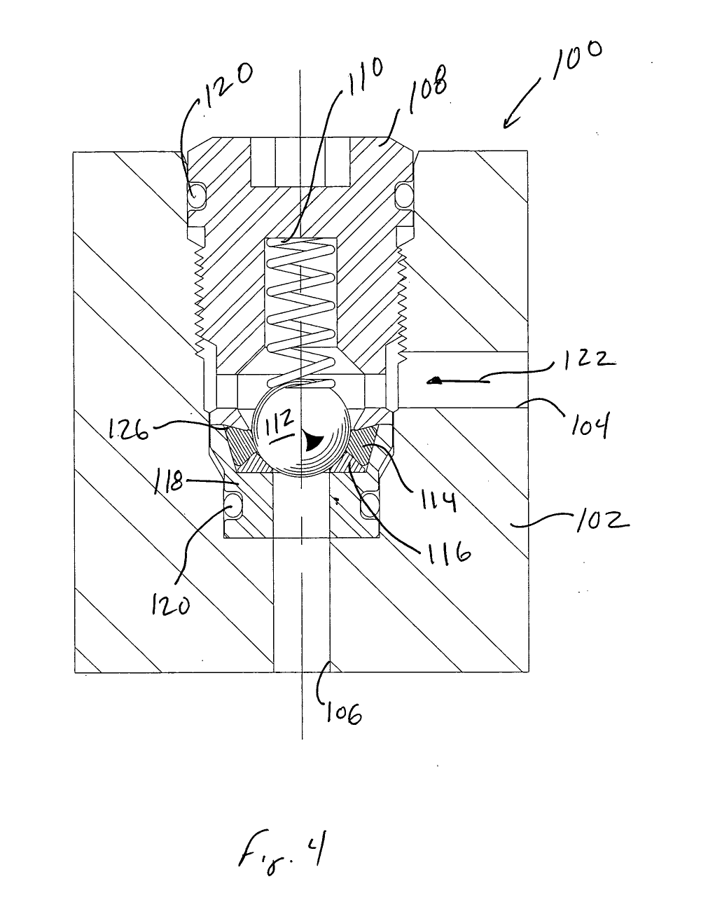

FIG. 4 illustrates valve assembly 100 in a closed position operating against flow 122 in a checked direction. As the fluid pressure is increased in port 104, closure member 112 compresses primary sealing element 114 into groove 126 until the closure member is in sealing contact with the secondary sealing element 116. This sealing contact is initially at a sealing diameter that increases as primary sealing element 114 is compressed. During this compression, the sealing element expands radially into groove 126 and moves upward and outward along closure member 112. The axial movement of closure member 112 relative to primary sealing element 114 not only provides a sealing engagement but also acts as a wiper, cleaning debris from the surface of the closure member.

Thus, as closure member 112 transitions from the position of initial engagement with primary sealing element 114, as shown in FIG. 3, to the final position of engagement with the secondary sealing element 116, the outer sealing surface of the closure member is wiped clean of sand and debris by primary sealing element 114. This wiping action ensures that even in the presence of a high solids content flow, the sealing diameter between closure member 112 and sealing element 114 has a sealing engagement that is substantially free of debris.

Secondary sealing element 116 provides a redundant sealing interface and limits the axial translation of closure member 112 relative to sealing element 114. In certain applications, sealing element 116 also provides a sealing material substantially impermeable to gas. One problem with elastomeric seals is that some elastomeric materials are susceptible to explosive decompression in high pressure gas environments with rapidly changing pressures. High pressure gas can permeate into the elastomeric material and, when the pressure rapidly drops, the gas within the seal rapidly expands and can damage the seal. The construction of secondary sealing element 116 from a polymeric, or other suitable, material improves the performance of the valve in gas environments. In non-gas environments, other materials may be used.

The combination of the primary 114 and secondary 116 sealing elements thus provides a redundant sealing engagement with closure member 112. The wiping action of primary sealing element 114 also allows the utilization of considerably lower spring force, thereby lowering the free flow cracking pressure. This lower cracking pressure greatly reduces the localized fluid flow velocity through gap 132, thereby reducing erosion on the closure member and the sealing elements.

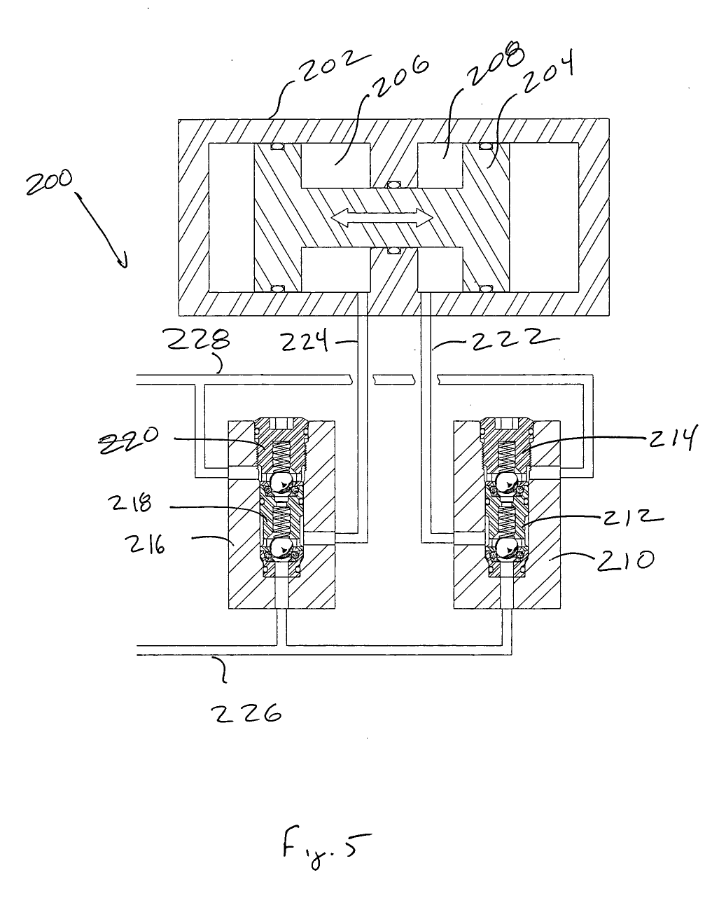

One exemplary use of a check valve assembly is in a reciprocating piston-style pump as shown in FIG. 5. Pump assembly 200 includes body 202 and a reciprocating piston 204 forming pumping chambers 206 and 208. Assembly 200 also includes two dual check valve assemblies 210 and 216. Check valve assembly 210 includes inlet check valve 212 and outlet check valve 214. Check valve assembly 216 includes inlet check valve 218 and outlet check valve 220. Flow line 222 provides fluid communication between check valve assembly 210 and chamber 208. Flow line 224 provides fluid communication between check valve assembly 216 and chamber 206. Inlet line 226 provides fluid to pump assembly 220 and outlet line 228 carries fluid from the assembly.

In operation, as piston 204 moves to the right, chamber 208 increases in size and chamber 206 decreases in size. The increase in size of chamber 208 causes a pressure drop in line 222, which connects to valve assembly 210 between inlet check valve 212 and outlet check valve 214. This decrease in pressure closes outlet check valve 214 and opens inlet check valve 212 pulling fluid from inlet line 226. The fluid from inlet line 226 flows through inlet check valve 212 and line 222 into chamber 208. The decrease in size of chamber 206 causes a pressure increase in line 224, which connects to valve assembly 216 between inlet check valve 218 and outlet check valve 220. This increase in pressure closes inlet check valve 218 and opens outlet check valve 220 allowing fluid to flow into outlet line 228. The fluid from line 224 flows through outlet check valve 220 and into outlet line 228.

As piston 204 moves to the left, the reverse procedure occurs and chamber 206 increases in size as chamber 208 decreases in size. The increase in size of chamber 206 causes a pressure drop in line 224, which connects to valve assembly 216 between inlet check valve 218 and outlet check valve 220. This decrease in pressure closes outlet check valve 220 and opens inlet check valve 218 pulling fluid from inlet line 226. The fluid from inlet line 226 flows through inlet check valve 218 and line 224 into chamber 206. The decrease in size of chamber 208 causes a pressure increase in line 222, which connects to valve assembly 210 between inlet check valve 212 and outlet check valve 214. This increase in pressure closes inlet check valve 212 and opens outlet check valve 214 allowing fluid to flow into outlet line 228. The fluid from line 222 flows through outlet check valve 214 and into outlet line 228.

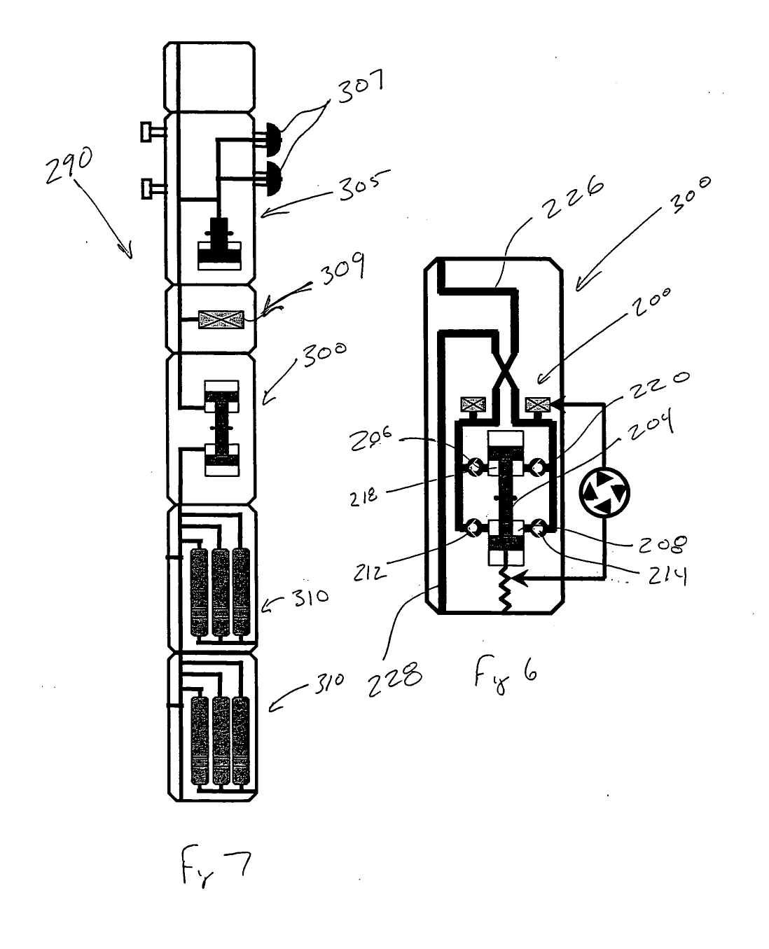

Referring now to FIGS. 6 and 7 a schematic representation of a downhole formation testing tool 290 is shown. Tool 290 comprises a dual probe section 305, gauge section 309, pump section 300, and multi-chamber sections 310. Probe section 305 includes two sample acquisition probes 307 that engage the wall of a wellbore and provide a fluid conduit between the formation surrounding the wellbore and tool 290. Gauge section 309 provides analytical tools for evaluating the properties, such as density, viscosity, etc, of the fluid drawn into the tool. Multi-chamber sections 310 provide storage containers for samples of fluid that are collected for return to the surface for further evaluation.

Pump section 310 includes the components described in reference to FIG. 5. Section 310 includes pump assembly 200 including reciprocating piston 204 forming pumping chambers 206 and 208. Inlet check valves 212 and 218 allow fluid to flow from flowline 226 into chambers 206 and 208. Outlet check valves 208 and 220 allow fluid to flow out of chambers 206 and 208 into flowline 228. Pump assembly 200 operates to draw fluid into probe section 305 and through flowlines 226 and 228 out to multi-chamber sections 310.

While preferred embodiments of this invention have been shown and described, modifications thereof can be made by one skilled in the art without departing from the scope or teaching of this invention. The embodiments described herein are exemplary only and are not limiting. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims.

1. A check valve comprising:
a first port and a second port in fluid communication with each other;
a first sealing element retained within a groove disposed circumferentially about the second port;
a closure member adapted to sealingly engage said first sealing element along a sealing diameter so as to isolate said first port from said second port;
a spring adapted to urge said closure member into sealing engagement said first sealing element, wherein fluid pressure in said first port further causes said closure member to translate axially relative to said first sealing member, said first sealing element to expand into the groove, and the sealing diameter to increase.

2. The check valve of claim 1 further comprising a second sealing element adapted to sealingly engage said closure member and limit the axial translation of the closure member relative to said first sealing member.

3. The check valve of claim 2 wherein said second sealing element forms at least a portion of the groove retaining said first sealing element.

4. The check valve of claim 2 wherein said first sealing element is more compliant than said second sealing element.

5. The check valve of claim 2 wherein said second sealing element is a polymeric seal.

6. The check valve of claim 5 wherein said second sealing element has a triangular cross-section.

7. The check valve of claim 1 wherein said first sealing element is an elastomeric o-ring.

8. The check valve of claim 1 wherein said closure member is a ball.

9. The check valve of claim 1 wherein the groove is a dove-tailed groove.

10. The check valve of claim 1 wherein said first sealing element wipes debris from said closure member as the sealing diameter increases.

11. The check valve of claim 1 wherein fluid pressure in said second port compresses said spring and moves said closure member out of sealing engagement with said first sealing element.

12. A valve assembly comprising:
a valve body having first and second ports;
a closure member disposed within said body, wherein said closure member is axially translatable between a first position allowing hydraulic communication between the first and second ports and a second position preventing hydraulic communication between the first and second ports;
a first sealing element adapted to circumferentially engage said closure member along a sealing diameter when said closure member is in the second position, wherein, the sealing diameter increases as said closure member translates between the first and second position; and
a second sealing element adapted to circumferentially engage said closure member when said closure member is in the second position, wherein said second sealing element limits the axial translation of said closure member.

13. The valve assembly of claim 12 further comprising a groove retaining said first sealing element, wherein said groove is sized so as to allow the sealing diameter of the first sealing element to increase.

14. The valve assembly of claim 13 wherein said groove is at least partially formed by said second sealing element.

15. The valve assembly of claim 12 wherein said first sealing element is more compliant than said second sealing element and said second sealing element is more compliant than said body.

16. The valve assembly of claim 12 wherein said first sealing element wipes said closure member as said closure member translates between the first and second positions.

17. The valve assembly of claim 12 wherein said second sealing element is suited for use in a high pressure gas environment.

18. A method for constructing a check valve, the method comprising:
disposing an axially translatable closure member within a body having a flow path therethrough;
providing a first sealing element such that the flow of fluid in a first direction through the flow path urges the closure member into sealing engagement with the first sealing element such that the first sealing element diametrically expands as the closure member translates axially relative to first sealing element; and
providing a spring urging said closure member into sealing engagement with the first sealing element, wherein the flow of fluid in a second direction through the flow path will compress said spring and allow fluid to pass between the first sealing element and the closure member.

19. The method of claim 18 further comprising, providing a second sealing element that sealingly engages the closure member and limits the axial translation of the closure member when fluid flows in the first direction.

20. The method of claim 19 wherein the first sealing element is an o-ring and the second sealing element has a triangular cross-section, wherein the first sealing element is more compliant than the second sealing element, which is more compliant than the body.
